(19) United States
(12) Patent Application Publication
(10) Pub. No.: US 2025/0028555 A1
(43) Pub. Date: Jan. 23, 2025

(54) DATA FLOW MANAGEMENT SYSTEM AND DATA FLOW MANAGEMENT METHOD

(71) Applicants: Digiwin Software Co., Ltd, Shanghai (CN); DATA SYSTEMS CONSULTING CO., LTD., New Taipei City (TW)

(72) Inventors: Cong Zhou, Shanghai (CN); Qinzhang Zhu, Shanghai (CN); Guoxin Sun, Shanghai (CN)

(73) Assignees: Digiwin Software Co., Ltd, Shanghai (CN); DATA SYSTEMS CONSULTING CO., LTD., New Taipei City (TW)

(21) Appl. No.: 18/463,307

(22) Filed: Sep. 8, 2023

(30) Foreign Application Priority Data
Jul. 19, 2023 (CN) 202310890194.6

(51) Int. Cl. G06F 9/48; G06F 9/30

(52) U.S. Cl. CPC G06F 9/4887; G06F 9/30058; G06F 9/485

(57) ABSTRACT

A data flow management system and a data flow management method are provided. The data flow management system includes a memory and a processor electrically connected to the memory and executing a data flow. The processor executes task nodes in the data flow, generates output data, and determines whether a data state of the output data reaches a target data state to decide whether to acquire a next task node in the data flow. When the processor determines the data state of the output data does not reach the target data state, the processor acquires the next task node and decides to execute the next task node in a data branching mode or a data shunting mode according to a data feature set and a branch identifier. When the processor determines the data state of the output data reaches the target data state, the processor ends the data flow.

### CROSS-REFERENCE TO RELATED APPLICATION

This application claims the priority benefit of China application serial no. 202310890194.6, filed on Jul. 19, 2023. The entirety of the above-mentioned patent application is hereby incorporated by reference herein and made a part of this specification.

### BACKGROUND

### Technical Field

The disclosure relates to an efficient and automated data processing flow; more particularly, the disclosure relates to a data flow management system and a data flow management method.

### Description of Related Art

In the context of Enterprise Resource Planning (ERP) systems, achieving automated business data flow involves executing relevant business logic through a computer to facilitate corresponding business processing and management. As businesses grow in complexity and deal with larger data volumes, the data flow required may extend beyond a single execution path. However, current methods for handling the business data flow lack the capability to perform a data branching operation and a data shunting operation within the flow. Consequently, when dealing with intricate business processes, conventional business processing flows simply allow repeated executions of at least a portion of the flow to achieve business targets. The conventional business processing flow lacks functions for data branching and data shunting, compelling the system to carry out business tasks repeatedly for the same or different sets of data in input data. This redundancy leads to a waste of computing resources and a decline in computing efficiency.

### SUMMARY

The disclosure provides a data flow management system and a data flow management method capable of achieving an efficient and automated data processing flow.

According to an embodiment of the disclosure, a data flow management system includes a memory and a processor. The processor is electrically connected to the memory and configured to execute a data flow. The processor executes task nodes in the data flow and generates output data. The processor determines whether a data state of the output data reaches a target data state, so as to decide whether to acquire a next task node of the task nodes in the data flow. When the processor determines that the data state of the output data does not reach the target data state, the processor acquires the next task node, and the processor decides whether to execute the next task node in a data branching mode, a data shunting mode, or a path selection mode according to a data feature set and a branch identifier. When the processor determines that the data state of the output data reaches the target data state, the processor ends the data flow.

According to an embodiment of the disclosure, a data flow management method includes following steps. A data flow is executed through a processor. Task nodes in the data flow are executed through the processor, and output data are generated. Whether a data state of the output data reaches a target data state is determined through the processor, so as to decide whether to acquire a next task node of the task nodes in the data flow. When the processor determines that the data state of the output data does not reach the target data state, the next task node is acquired through the processor, and whether to execute the next task node in a data branching mode, a data shunting mode, or a path selection mode is determined according to a data feature set and a branch identifier through the processor. When the processor determines that the data state of the output data reaches the target data state, the data flow is ended.

The data flow management system and the data flow management method provided in one or more embodiments of the disclosure may be applied to decide whether to execute the next task node in the data branching mode or the data shunting mode according to the data feature set and the branch identifier, so as to achieve an efficient data processing flow.

Several exemplary embodiments accompanied with figures are described in detail below to further describe the disclosure in details.

### BRIEF DESCRIPTION OF THE DRAWINGS

The accompanying drawings are included to provide a further understanding of the disclosure, and are incorporated in and constitute apart of this specification. The drawings illustrate exemplary embodiments of the disclosure and, together with the description, serve to explain the principles of the disclosure.

FIG. 1 is a schematic diagram of a data flow management system according to an embodiment of the disclosure.

FIG. 2 is a flowchart of a data flow management method according to an embodiment of the disclosure.

FIG. 3 is a flowchart of a data flow management method according to an embodiment of the disclosure.

FIG. 4 is a flowchart of a data flow management method according to an embodiment of the disclosure.

FIG. 5A is a schematic diagram of data features according to an embodiment of the disclosure.

FIG. 5B is a schematic diagram of data branching according to an embodiment of the disclosure.

FIG. 6A is a schematic diagram of data features according to an embodiment of the disclosure.

FIG. 6B is a schematic diagram of data shunting according to an embodiment of the disclosure.

FIG. 7 is a schematic diagram of path selection according to an embodiment of the disclosure.

FIG. 8A is a schematic diagram of input data according to an embodiment of the disclosure.

FIG. 8B is a schematic diagram of a data feature set according to an embodiment of the disclosure.

FIG. 9A is a schematic diagram of data branching according to an embodiment of the disclosure.

FIG. 9B is a schematic diagram of data branching according to an embodiment of the disclosure.

FIG. 10A is a schematic diagram of input data according to an embodiment of the disclosure.

FIG. 10B is a schematic diagram of a data feature set according to an embodiment of the disclosure.

FIG. 11A is a schematic diagram of a task node according to an embodiment of the disclosure.

FIG. 11B is a schematic diagram of a task node according to an embodiment of the disclosure.

FIG. 11C is a schematic diagram of a task node according to an embodiment of the disclosure.

FIG. 12A is a schematic diagram of data shunting according to an embodiment of the disclosure.

FIG. 12B is a schematic diagram of data shunting according to an embodiment of the disclosure.

### DESCRIPTION OF THE EMBODIMENTS

Reference will now be made in detail to the embodiments of the disclosure, examples of which are illustrated in the accompanying drawings. Wherever possible, the same reference numbers are used in the drawings and the description to refer to the same or like parts.

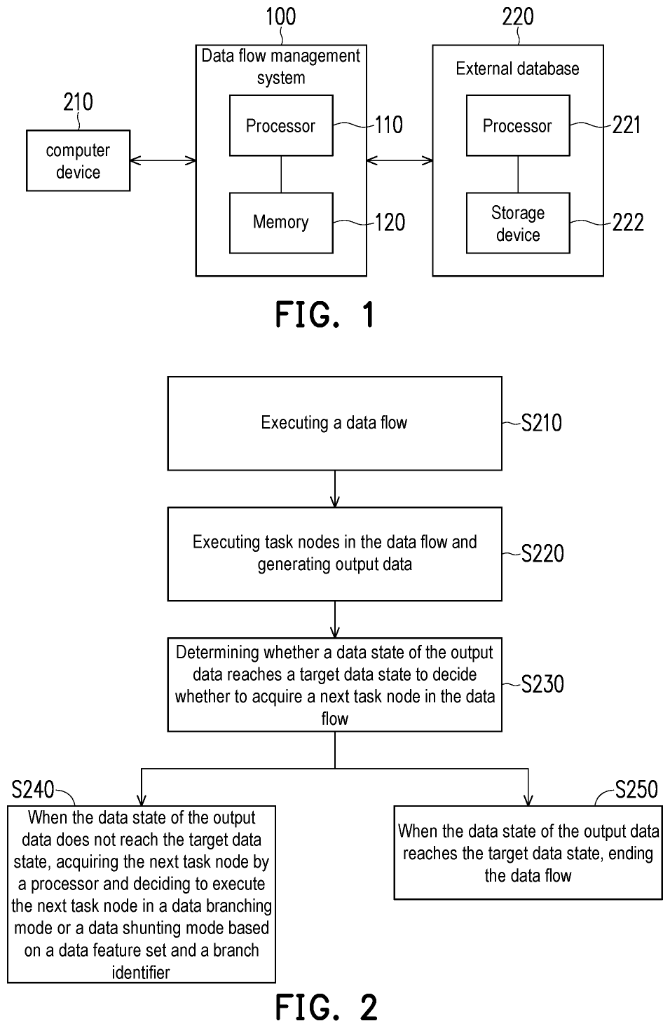

FIG. 1 is a schematic diagram of a data flow management system according to an embodiment of the disclosure. With reference to FIG. 1, a data flow management system 100 includes a processor 110 and a memory 120. The processor 110 is electrically connected to the memory 120. In this embodiment, the data flow management system 100 may communicate with an external computer device 210 and an external database 220. The memory 120 may be configured to temporarily store source data, data states, data features, and so on during a data flow. In this embodiment, the external database 220 includes a processor 221 and a storage device 222. The processor 221 is electrically connected to the storage device 222. The storage device 222 may be configured to store relevant flow variables of the data flow, source data, and predefined data feature sets.

In this embodiment, a user may operate the computer device 210 to send a command or a signal to initiate a process request to the data flow management system 100, so that the processor 110 of the data flow management system 100 may access the data of the external database 220 and execute relevant algorithms, programs, and/or software of the data flow to create and execute a corresponding data flow.

In this embodiment, the processor 110 and the processor 221 may be a system on a chip (SOC) or, for instance, may include a central processing unit (CPU) or another programmable general-purpose or special-purpose microprocessor, digital signal processor (DSP), programmable controller, application specific integrated circuit (ASIC), programmable logic device (PLD), another similar processing device, or a combination thereof. In this embodiment, the memory 120 may be, for instance, a dynamic random access memory (DRAM), a flash memory, a non-volatile random access memory (NVRAM), or the like. In this embodiment, the storage device 222 may be, for instance, a disk.

FIG. 2 is a flowchart of a data flow management method according to an embodiment of the disclosure. With reference to FIG. 1 and FIG. 2, the data flow management system 100 may execute following steps S210-S250. In step S210, the processor 110 executes a data flow. In this embodiment, the data flow may be composed of a plurality of task nodes. In step S220, the processor 110 executes the task nodes in the data flow and generates output data. In this embodiment, a flow path is formed among the task nodes, and the output data of the previous task node serves as input data of the next task node. In step S230, the processor 110 determines whether a data state of the output data reaches a target data state to decide whether to acquire the next task node in the data flow. In this embodiment, the processor 110 may acquire the data state of the output data and match the data state with the data flow. The processor 110 may query the next task node in the data flow based on the data state, a data feature set, and a branch identifier. Moreover, when the processor 110 determines that there are a plurality of next task nodes, the processor 110 may decide whether to execute the next task nodes in a data branching mode or a data shunting mode based on the branch identifier.

In step S240, when the data state of the output data does not reach the target data state, the processor 110 acquires the next task node and decides to execute the next task node in a data branching mode or a data shunting mode based on the data feature set and the branch identifier. In step S250, when the data state of the output data reaches the target data state, the processor 110 ends the data flow. Therefore, the data flow management system and data flow management method provided in this embodiment may realize the data flow management function of data branching and data shunting.

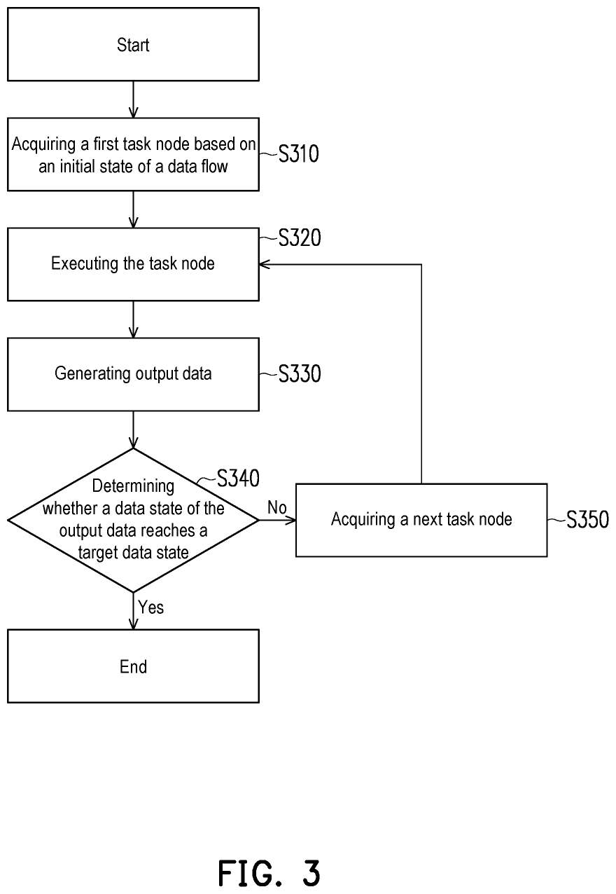

FIG. 3 is a flowchart of a data flow management method according to an embodiment of the disclosure. With reference to FIG. 1 and FIG. 3, the data flow management process may be implemented in the manner provided in following steps S310-S350. In step S310, the processor 110 acquires a first task node based on an initial state of the data flow. In this embodiment, the processor 110 may acquire the first task node and the data feature set. The data feature set refers to a collection of the same type of data features and may serve to identify the features on which the data in the process depends, such as an order gross profit rate feature set, a deposit ratio feature set, and so on. The data feature set may include a data feature set code, a data feature set name, and one or more data features. Each data feature in the data feature set includes a data feature code, feature name information, feature matching mode information, and feature matching rule information. In this embodiment, the feature matching rule information may be an expression or a request address of an application programming interface (API). When the feature matching rule information is configured to get a value from a flow variable, the processor 110 executes the next task node in a data branching mode.

In step S320, the processor 110 executes the task node. In step S330, the processor 110 generates output data. In this embodiment, the output data include a data state code, a data state name, and a data feature. Moreover, the output data serves as the input data for the next task node. In step S340, the processor 110 determines whether the data state of the output data reaches the target data state. In this regard, the processor 110 may determine whether the data state code of the output data and the data state code of the target data are consistent. If yes, the processor 110 ends the execution of the data flow. If not, in step S350, the processor 110 acquires the next task node and re-executes step S320.

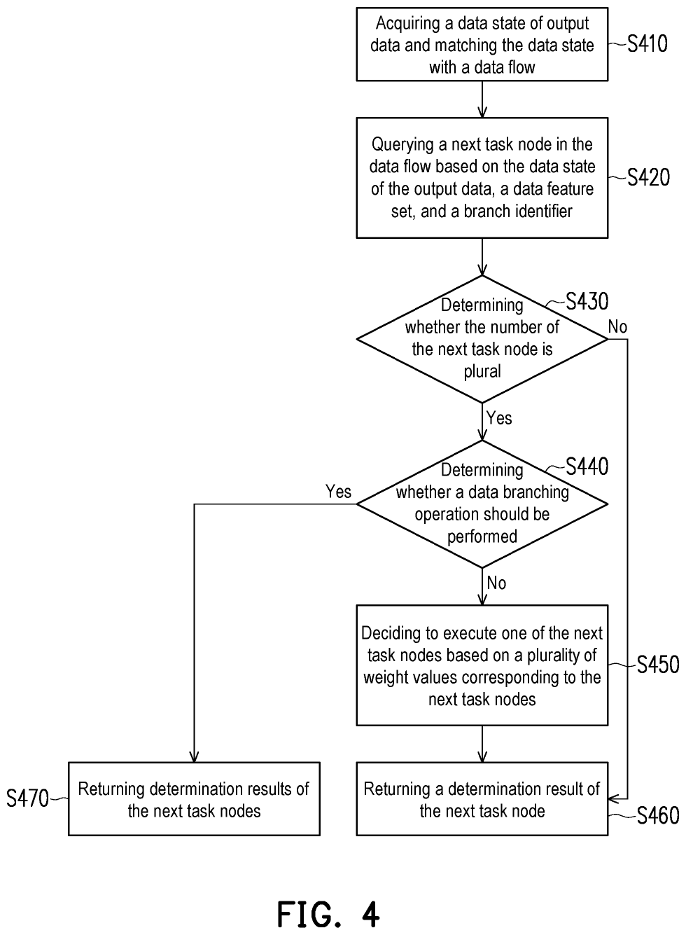

FIG. 4 is a flowchart of a data flow management method according to an embodiment of the disclosure. With reference to FIG. 1 and FIG. 4, the specific process for determining the next task node in step S320 depicted in FIG. 3 may be implemented in the manner as provided in steps S410-S470. In step S410, the processor 110 acquires the data state of the output data and matches the data state with the data flow. In this embodiment, the data state may include a data state code, a data state name, and a data feature. In this regard, the data state may be applied to advance the progress of the data flow. Under a data-driven flow mode, the processor 110 may select a flow node through the data state of the input data, and after the flow node (the task node) is executed, the output data are generated. The data state of the output data becomes the data state of the input data for the next node, and the rest may be deduced therefrom. In the flow, when the data state of the output data finally reaches the target data state, the processor 110 ends the data flow.

In step S420, the processor 110 queries the next task node in the data flow based on the data state of the output data, the data feature set, and the branch identifier. In this embodiment, the processor 110 may match the data feature in the output data with the data in the data flow. Further, the branch identifier is defined in the task node. When the processor 110 searches the next node, the processor 110may match a plurality of task nodes through the data state and the data feature set. In this regard, if the branch identifier is set in the data, all matched task nodes are returned; if no branch identifier is set in the data, only the task node with the highest score is returned. In step S430, the processor 110 determines whether the number of the next task node is plural. If not, in step S460, the processor 110 returns the determination result of the next task node. If yes, in step S440, the processor 110 determines whether the data branching operation should be performed. In this embodiment, the processor 110 may determine whether to perform the data branching operation based on the branch identifier. If yes, in step S470, the processor 110 returns the determination results of the next task nodes. If not, in step S450, the processor 110 decides to execute one of the next task nodes based on a plurality of weight values corresponding to the next task nodes. In this embodiment, the processor 110 may perform a sorting operation according to the (feature) weight value of each of the task nodes to determine the task node with the highest weight value, and the processor 110 may select to execute one of the next task nodes corresponding to the highest weight value. In other words, the processor 110 may perform a path selection function of the task node. In step S460, the processor 110 returns the determination result of the next task node. Therefore, the data flow management system and the data flow management method provided in this embodiment may automatically determine whether to execute the next task node in a data branching mode or a data shunting mode, so as to achieve an efficient data processing flow.

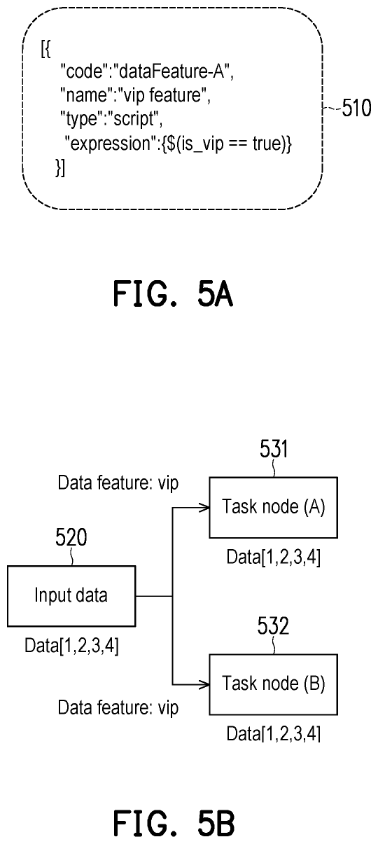

FIG. 5A is a schematic diagram of data features according to an embodiment of the disclosure. FIG. 5B is a schematic diagram of data branching according to an embodiment of the disclosure. With reference to FIG. 1, FIG. 5A, and FIG. 5B, the implementation of the data branching mode is explained in this embodiment. Note that data structures of the data described in the following embodiments may be exemplified by but should not be limited to JSON (JavaScript Object Notation) format data. In other embodiments of the disclosure, the data structures of the data described in each embodiment may also be implemented in hierarchical data formats, such as extensible markup language (XML), TOML (Tom's Obvious, Minimal Language), CSON (Cursive Script Object Notation), YAML, and so on.

As shown in FIG. 5A, the data features in the data feature set 510 may include a data feature code “code”, feature name information “name”, feature matching mode information “type”, and feature matching rule information “expression”. The data feature code “code” may be “dataFeature-A”. The feature name information “name” may be a “vip” feature. The feature matching mode information “type” may be “script”. The feature matching rule information “expression” may be “$(is_vip==true)” (i.e., script). As shown in FIG. 5B, the input data 520 may include data [1,2,3,4]. In this embodiment, the processor 110 may search for task nodes with the same “vip” feature in the data flow according to the feature name information “name” in the data feature set 510, so as to acquire a task node (A) 631 and a task node (B) 632 determine to get a value from a flow variable according to the feature matching mode information “type” and the feature matching rule information “expression” in the data features, thus deciding to perform the data branching operation on the task node (A) 631 and the task node (B) 632 according to the input data 520. In other words, the processor 110 may input the data [1,2,3,4] of the input data 520 into logic units of the task node (A) 631 and the task node (B) 632, respectively, so as to perform the corresponding logic operation. Therefore, the data flow management system 100 may implement the process operation scenario of data branching during the execution of the data flow.

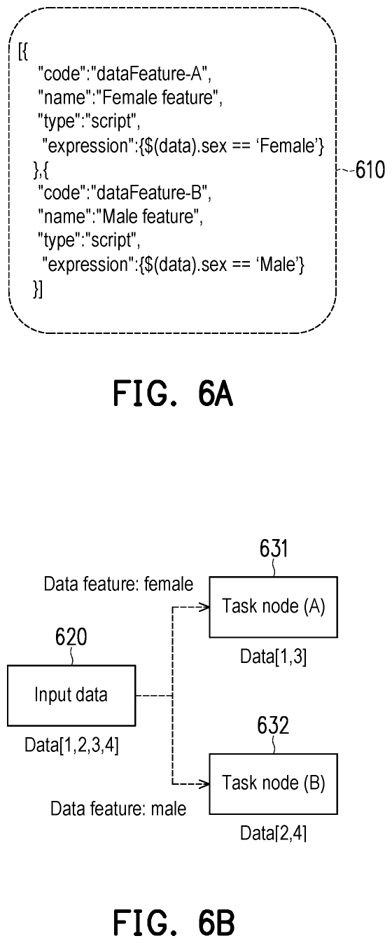

FIG. 6A is a schematic diagram of data features according to an embodiment of the disclosure. FIG. 6B is a schematic diagram of data shunting according to an embodiment of the disclosure. With reference to FIG. 1, FIG. 6A, and FIG. 6B, the implementation of the data shunting mode is explained in this embodiment. As shown in FIG. 6A, the data feature set 610 may include two data features, where the data feature code “code” of one of the data features may be “dataFeature-A”. The feature name information “name” may be “female feature”. The feature matching mode information “type” may be “script”. The feature matching rule information “expression” may be “$(data).sex==‘female’” (i.e., script). The data feature code “code” of the other data feature may be “dataFeature-B”. The feature name information “name” may be “male feature”. The feature matching mode information “type” may be “script”. The feature matching rule information “expression” may be “$(data).sex==‘male’” (i.e., script).

As shown in FIG. 6B, the input data 620 may include data [1,2,3,4]. In this embodiment, the processor 110 may search for task nodes in the data flow that are also the “female feature” and the “male feature” according to the feature name information “name” of the two data features in the data feature set 610, so as to acquire a task node A and a task node B and determine to get a value from a flow variable according to the feature matching mode information “type” and the feature matching rule information “expression” in the data features, thus deciding to perform the data shunting operation on the task node 631 and the task node 632 according to the input data 620. In other words, the processor 110 may input the data [1,3] of the input data 620 into a logic unit of the task node 631 to perform the corresponding logic operation. Alternatively, the processor 110 may input the data [2,4] of the input data 620 into a logic unit of the task node 632 to perform the corresponding logic operation. The processor 110 may perform a path selection operation to choose to execute the task node 631 or the task node 632.

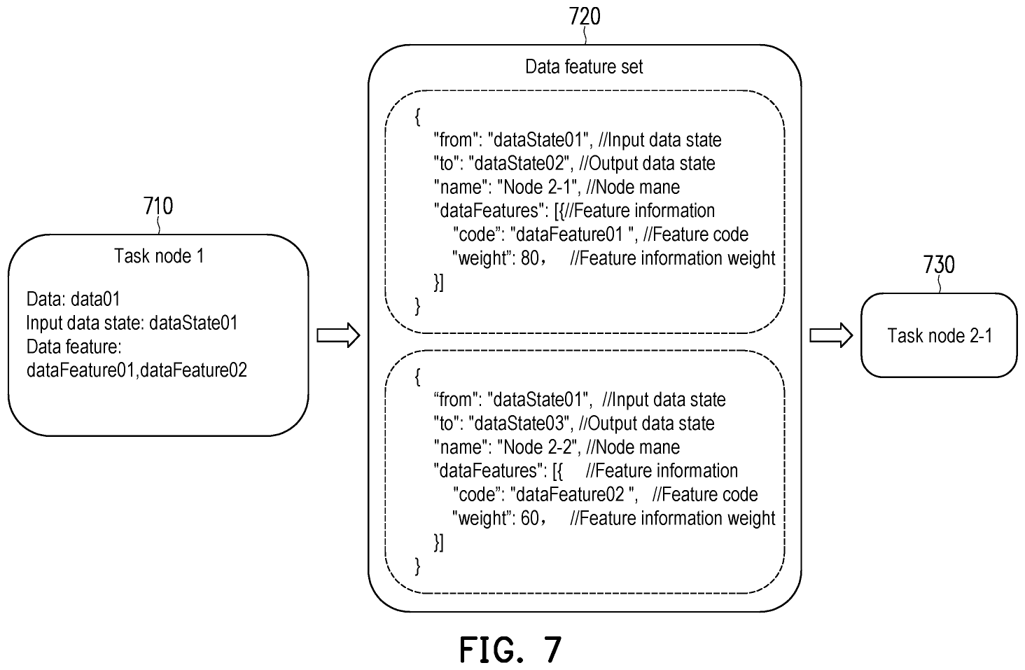

FIG. 7 is a schematic diagram of path selection according to an embodiment of the disclosure. With reference to FIG. 1 and FIG. 7, the implementation of the method of path selection is explained in this embodiment. According to this embodiment, a task node (1) 710 may generate input data for the next task node, which includes data “data01”, an input data state “dataState01”, and data features “dataFeature01” and “dataFeature02”. A data feature set 720 may include the data features of two task nodes (2-1) and (2-2). The data feature of the task node (2-1) includes the input data state “dataState01”, an output data state “dataState02”, a node name “node 2-1”, a feature code “dataFeature01”, and a weight value “80” of the weight of the feature. The data feature of the task node (2-2) includes the input data state “dataState01”, the output data state “dataState02”, a node name “node 2-2”, a feature code “dataFeature02”, and a weight value “60” of the weight of the feature.

In this embodiment, the processor 110 may acquire the two task nodes (2-1) and (2-2) following the task node (1) 710 based on the input data state “dataState01” of the input data, and the processor 110 may determine that the two data features “dataFeature01” and “dataFeature02” respectively match the task nodes (2-1) and (2-2). In this regard, the processor 110 may compare and learn that the weight (the weight value 80) of the feature of the task node (2-1) is higher than the weight (the weight value 60) of the feature of the task node (2-2); therefore, the processor 110 reports the task node (2-1) as the next task node (2-1) to be executed. Accordingly, based on the data branching method and the current path selection method described in the above embodiments, the data flow management system 100 may implement the process operation scenario of data branching during the execution of the data flow.

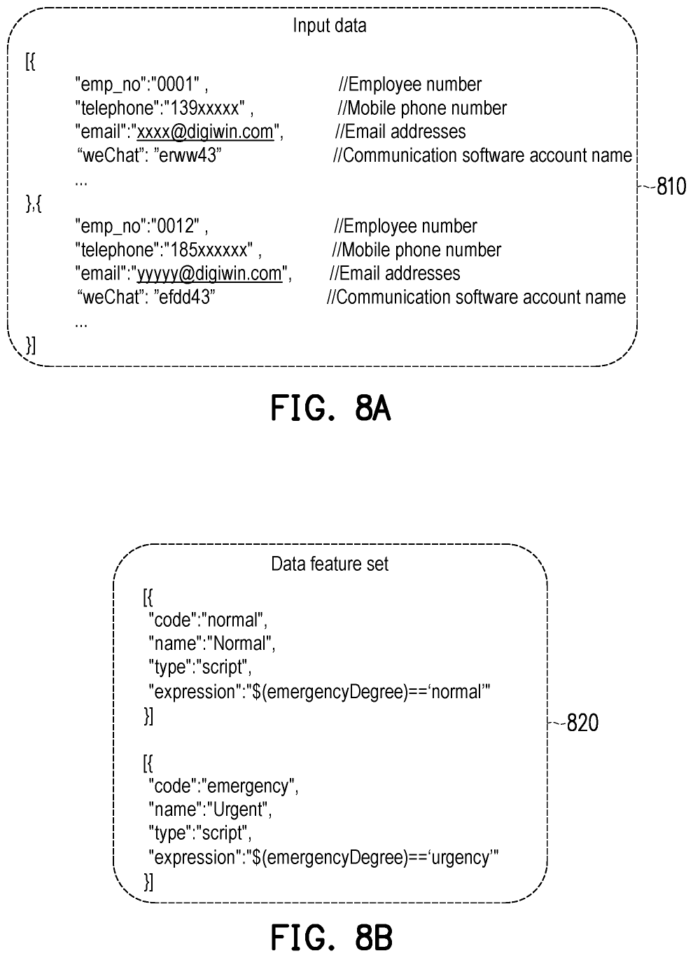

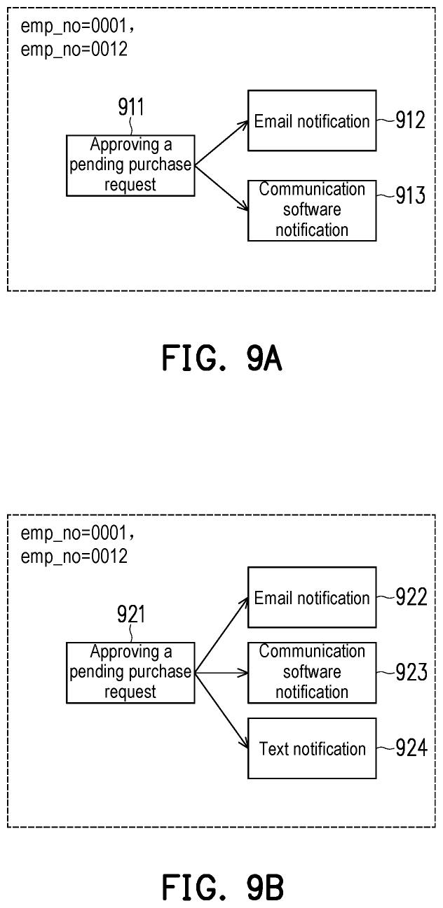

FIG. 8A is a schematic diagram of input data according to an embodiment of the disclosure. FIG. 8B is a schematic diagram of a data feature set according to an embodiment of the disclosure. FIG. 9A is a schematic diagram of data branching according to an embodiment of the disclosure. FIG. 9B is a schematic diagram of data branching according to an embodiment of the disclosure. Here, FIG. 8A to FIG. 9B illustrate exemplary embodiments of data branching in the disclosure. With reference to FIG. 8A, input data 810 may include a plurality of data. For instance, first data may include an employee number ″“emp_no”:“0001”″, a mobile phone number ″“telephone”:“139xxxxx”″, an email address ″“email”:“xxxx@digiwin. com”″, and a communication software account name ″“wechat”:“erww43”″; second data may include an employee number ″“emp_no”:“0012”″, a mobile phone number ″“telephone”:“185xxxxxx”″, an email address ″“email”:“yyyyy@digiwin. com”″, and a communication software account name ″“wechat”:“efdd43”″.

With reference to FIG. 8B, a data feature set 820 may include a plurality of data features. For instance, a first data feature may include a data feature code ″“code”:“normal”″, feature name information ″“name”:“general”″, feature matching mode information ″“type”:“script”″, and feature matching rule information ″“expression”:“$(emergencyDegree)==‘normal’”″; a second data feature may include the data feature code ″“code”:“normal”″, the feature name information ″“name”:“general”″, the feature matching mode information ″“type”:“script”″, and the feature matching rule information ″“expression”:“$(emergencyDegree)==‘normal’”″.

With reference to FIG. 1 and FIG. 9A, a task node 911 may serve to execute an operation of approving a pending purchase request. The task node 911 may output relevant data of the pending purchase request and perform data branching based on the input data state and the data features. In this regard, the processor 110 may decide the notification methods to be used to notify an approver based on the emergency of the pending purchase request. Specifically, the processor 110 may match the flow data and the conditions of the data features to obtain a data feature of an emergency level, and the processor 110 may obtain the information of the emergency level by determining the data feature of the emergency level. As shown in FIG. 9A, if the emergency level is general, the processor 110 determines the subsequent execution of task nodes 912 and 913 based on the data feature set 820 in FIG. 8A, so as to obtain a plurality of branch tasks to process the same data differently. The task node 912 may serve to notify the users corresponding to the employee numbers ″“emp_no”:“0001”″ and ″“emp_no”:“0012”″ by sending emails to the email addresses ″“email”:“xxxx@digiwin.com”″ and ″“email”:“yyyyy@digiwin.com”″ in the input data in FIG. 8B. The task node 913 may serve to notify the users corresponding to the employee numbers ″“emp_no”:“0001”″ and ″“emp_no”:“0012”″ through the communication software account names ″“wechat”:“erww43”″ and ″“wechat”:“efdd43”″ in the input data in FIG. 8B.

Alternatively, with reference to FIG. 1 and FIG. 9B, the task node 921 may serve to execute an operation of approving a pending purchase request. The task node 921 may output the relevant data of the pending purchase request and perform data branching based on the input data state and the data features. As shown in FIG. 9B, if the emergency level indicates “urgent”, the processor 110 determines the subsequent execution of task nodes 922, 923, and 924 according to the data feature set 820 in FIG. 8A, so as to acquire a plurality of branch tasks to process the same data differently. The task node 922 may serve to notify users corresponding to the employee numbers “emp_no”:“0001” and “emp_no”:“0012” by sending emails to the email addresses “email”:“xxxx@digiwin.com” and “email”:“yyyyy@digiwin.com” in the input data in FIG. 8B. The task node 923 may serve to notify the users corresponding to the employee numbers “emp_no”:“0001” and “emp_no”:“0012” via communication software based on the communication software account names “wechat”:“erww43” and “wechat”:“efdd43” in the input data in FIG. 8B. The task node 924 may serve to send text messages to the users corresponding to the employee numbers “emp_no”:“0001” and “emp_no”:“0012” based on the mobile phone numbers “telephone”:“139xxxxx” and “telephone”:“185xxxxxx” in the input data in FIG. 8B.

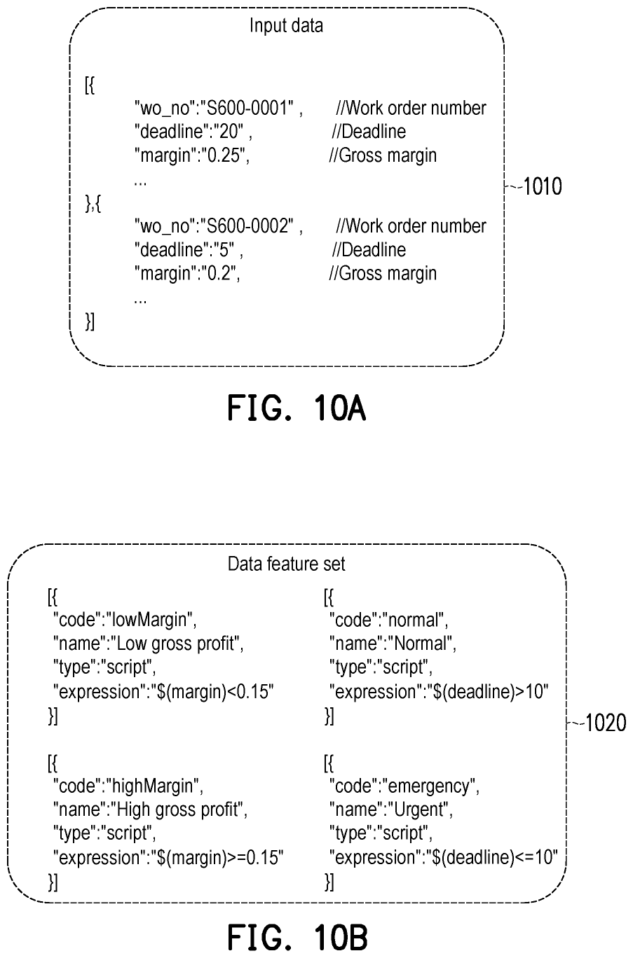

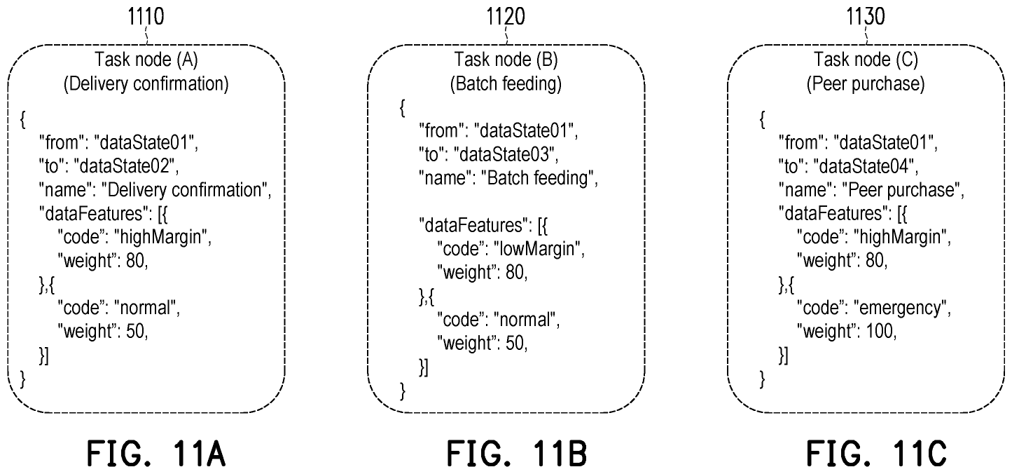

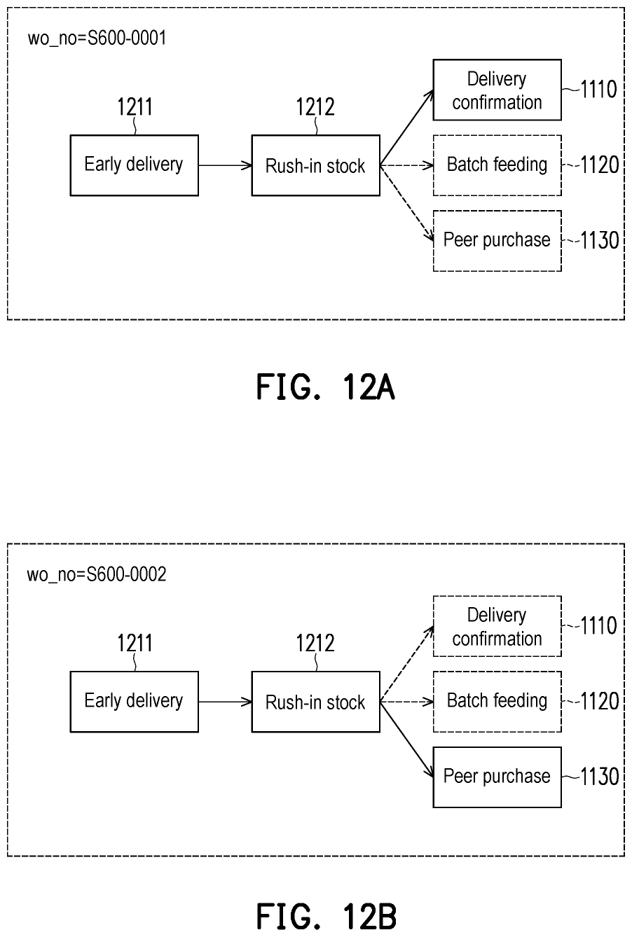

FIG. 10A is a schematic diagram of input data according to an embodiment of the disclosure. FIG. 10B is a schematic diagram of a data feature set according to an embodiment of the disclosure. FIG. 11A is a schematic diagram of a task node according to an embodiment of the disclosure. FIG. 11B is a schematic diagram of a task node according to an embodiment of the disclosure. FIG. 11C is a schematic diagram of a task node according to an embodiment of the disclosure. FIG. 12A is a schematic diagram of data shunting according to an embodiment of the disclosure. FIG. 12B is a schematic diagram of data shunting according to an embodiment of the disclosure. Here, FIG. 10A to FIG. 12B illustrate exemplary embodiments of data shunting in the disclosure. In this embodiment, a process data activation flow may be achieved, where the data flow may include task nodes of shipping, starting work, delivery, and so on. Therefore, the system may predefine two data feature sets, which may be, for instance, a days-in-advance feature set and an order gross profit feature set. The days-in-advance feature set may include urgent features and general features. The order gross profit feature set may include a high gross profit feature and a low gross profit feature.

With reference to FIG. 10A, input data 1010 may include a plurality of data entries. For instance, the first data entry may include the work order number “wo_no”: “S600-0001”, the deadline “deadline”: “20”, and the gross margin “margin”: “0.25”. The second data entry may include the work order number “wo_no”: “S600-0002”, the deadline “deadline”: “5”, and the gross margin “margin”: “0.2”.

With reference to FIG. 10B, the data feature set 1020 may be a plurality of data feature sets. For instance, a first data feature of a first data set may include a data feature code “code”: “lowMargin”, feature name information “name”: “low gross profit”, feature matching mode information “type”: “script”, and feature matching rule information “expression”:“$(margin)<0.15”; a second data feature of the first data set may include a data feature code “code”: “highMargin”, feature name information “name”: “high gross profit”, the feature matching mode information “type”: “script”, and feature matching rule information “expression”: “$(margin)>=0.15”; a first data feature of a second data set may include a data feature code “code”: “normal”, feature name information “name”: “general”, the feature matching mode information “type”: “script”, and feature matching rule information “expression”: “$(deadline)>10”; a second data feature of the second data set may include a data feature code “code”: “emergency”, feature name information “name”: “urgent”, the feature matching mode information “type”: “script”, and feature matching rule information “expression”: “$(deadline)<=10”.

With reference to FIG. 11A, a data feature of a task node (A) 1110 may include an input data state “from”: “dataState01”, an output data state “to”: “dataState02”, a node name “name”: “Delivery Confirmation”, a feature code “code”: “highMargin” and its corresponding feature weight “weight”: “80”, and a feature code “code”: “normal” and its corresponding feature weight “weight”: “50”. A data feature of a task node (B) 1120 may include the input data state “from”: “dataState01”, the output data state “to”: “dataState02”, a node name “name”: “Batch Feeding”, a feature code “code”: “lowMargin” and its corresponding feature weight “weight”: “80”, and the feature code “code”: “normal” and its corresponding feature weight “weight”: “50”. A data feature of a task node (C) 1110 may include the input data state “from”: “dataState01”, an output data state “to”: “dataState04”, a node name “name”: “Peer Purchase”, the feature code “code”: “highMargin” and its corresponding feature weight “weight”: “80”, and a feature code “code”: “emergency” and its corresponding feature weight “weight”: “100”.

With reference to FIG. 1 and FIG. 12A, for data of a work order number “S600-0001” in the input data 1010 in FIG. 10A, after the processor 110 executes a task node 1211 for early delivery and a task node 1212 for rush-in stock according to the input data 1010, the processor 110 may perform data shunting based on the input data state and the data features, so as to select one of the task nodes 1110-1130 as the next task node. The task node 1110 may serve to execute delivery confirmation. The task node 1120 may serve to execute batch feeding. The task node 1130 may serve to execute peer buying. As such, the processor 110 may make a determination based on the relevant data of the work order number “S600-0001” in the input data 1010 and the relevant data features of the data feature set in FIG. 10B. The processor 110 determines that a deadline ″“deadline”:“20”″ and a gross margin ″“margin”:“0.25”″ corresponding to the work order number “S600-0001” may match the feature code ″“code”:“highMargin” and the feature code ″“code”:c“normal” of the task node 1110 with a high gross margin and general emergency, and this task node has a higher weight value compared to the other task nodes. Therefore, the processor 110 may select the task node 1110 as the next task node and continue to execute the tasks by applying the relevant data corresponding to the work order number “S600-0001”.

With reference to FIG. 1 and FIG. 12B, for the data of a work order number “S600-0002” in the input data 1010 in FIG. 10A, after the processor 110 executes the task node 1211 for early delivery and the task node 1212 for rush-in stock according to the input data 1010, the processor 110 may perform data shunting based on the input data state and the data features to select one of the task nodes 1110-1130 as the next task node. As such, the processor 110 may make a determination based on the relevant data of the work order number “S600-0002” in the input data 1010 and the relevant data features of the data feature set in FIG. 10B. The processor 110 determines that a deadline ″“deadline”:“5”″ and a gross margin ″“margin”:“0.2”″ corresponding to the work order number “S600-0002” may match the feature code ″“code”:“highMargin” and the feature code ″“code”:“emergency” of the task node 1130 with a high gross margin and an urgent emergency level, and this task node has a higher weight value compared to other task nodes. Therefore, the processor 110 may select the task node 1130 as the next task node and continue to execute the tasks by applying the relevant data corresponding to the work order number “S600-0002”.

To sum up, the data flow management system and the data flow management method provided in one or more embodiments of the disclosure may be applied to automatically execute the next task node in the data branching mode or the data shunting mode to achieve an efficient data processing flow and effectively reduce the amount of computation required in the process of the data processing flow.

The data flow management system and the data flow management method provided in one or more embodiments of the disclosure may be applied to decide whether to execute the next task node in the data branching mode or the data shunting mode according to the data feature set and the branch identifier, so as to achieve an efficient data processing flow.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A data flow management system, comprising:
a memory; and
a processor, electrically connected to the memory and configured to execute a data flow,
wherein the processor executes task nodes in the data flow and generates output data,
wherein the processor determines whether a data state of the output data reaches a target data state, so as to decide whether to acquire a next task node of the task nodes in the data flow,
wherein when the processor determines that the data state of the output data does not reach the target data state, the processor acquires the next task node, and the processor decides whether to execute the next task node in a data branching mode or in a data shunting mode according to a data feature set and a branch identifier,
wherein when the processor determines that the data state of the output data reaches the target data state, the processor ends the data flow.

2. The data flow management system according to claim 1, wherein the processor uses the output data as input data for the next task node.

3. The data flow management system according to claim 1, wherein the processor acquires the data state of the output data and matches the data state with the data flow,
wherein the processor queries the next task node in the data flow according to the data state, the data feature set, and the branch identifier.

4. The data flow management system according to claim 3, wherein when the processor determines the number of the next task node is plural, the processor decides whether to execute the next task nodes in the data branching mode or in the data shunting mode according to the branch identifier.

5. The data flow management system according to claim 4, wherein when the processor decides to execute the next task nodes in the data shunting mode according to the branch identifier, the processor decides to execute one of the next task nodes according to a plurality of weight values corresponding to the next task nodes.

6. The data flow management system according to claim 5, wherein the processor selects to execute one of the next task nodes corresponding to a highest weight value of the weight values.

7. The data flow management system according to claim 1, wherein the data state of the output data comprises a data state code, a data state name, and a data feature.

8. The data flow management system according to claim 1, wherein each of data features in the data feature set comprises a data feature code, feature name information, feature matching mode information, and feature matching rule information.

9. The data flow management system according to claim 8, wherein when the feature matching rule information is configured to get a value from a flow variable, the processor executes the next task node in the data branching mode.

10. The data flow management system according to claim 8, wherein the feature matching rule information is an expression or a request address of an application programming interface.

11. A data flow management method, comprising:
executing a data flow through a processor;
executing task nodes in the data flow through the processor and generating output data;
determining whether a data state of the output data reaches a target data state through the processor, so as to decide whether to acquire a next task node of the task nodes in the data flow;
when the processor determines that the data state of the output data does not reach the target data state, acquiring the next task node through the processor, and deciding whether to execute the next task node in a data branching mode or a data shunting mode according to a data feature set and a branch identifier through the processor; and
when the processor determines that the data state of the output data reaches the target data state, ending the data flow.

12. The data flow management method according to claim 11, wherein the processor uses the output data as input data for the next task node.

13. The data flow management method according to claim 11, wherein the step of acquiring the next task node in the data flow comprises:
acquiring the data state of the output data through the processor and matching the data state with the data flow; and
querying the next task node in the data flow according to the data state, the data feature set, and the branch identifier through the processor.

14. The data flow management method according to claim 13, wherein the step of acquiring the next task node in the data flow further comprises:
when the processor determines the number of the next task node is plural, deciding whether to execute the next task nodes in the data branching mode or in the data shunting mode according to the branch identifier through the processor.

15. The data flow management method according to claim 14, wherein the step of acquiring the next task node in the data flow further comprises:
when the processor decides to execute the next task nodes in the data shunting mode according to the branch identifier, deciding to execute one of the next task nodes according to a plurality of weight values corresponding to the next task nodes through the processor.

16. The data flow management method according to claim 15, wherein the processor selects to execute one of the next task nodes corresponding to a highest weight value of the weight values.

17. The data flow management method according to claim 11, wherein the data state of the output data comprises a data state code, a data state name, and a data feature.

18. The data flow management method according to claim 11, wherein each of data features in the data feature set comprises a data feature code, feature name information, feature matching mode information, and feature matching rule information.

19. The data flow management method according to claim 18, wherein when the feature matching rule information is configured to get a value from a flow variable, the processor executes the next task node in the data branching mode.

20. The data flow management method according to claim 18, wherein the feature matching rule information is an expression or a request address of an application programming interface.
